(19) United States
(12) Patent Application Publication
(10) Pub. No.: US 2003/0021416 A1
(43) Pub. Date: Jan. 30, 2003

(54) Encrypting a messaging session with a symmetric key

(75) Inventors: Michael Wayne Brown, Georgetown, TX (US); Rabindranath Dutta, Austin, TX (US); Michael A. Paolini, Austin, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation

(21) Appl. No.: 09/915,974

(22) Filed: Jul. 26, 2001

(51) Int. Cl. H04L 9/00

(52) U.S. Cl. 380/277

(57) ABSTRACT

A method, system and program for encrypting a messaging session and providing users with a key for decrypting a messaging session are provided. A recording of a messaging session is encrypted with a symmetric key, wherein the symmetric key is enabled to decrypt the encrypted recording of the messaging session. The symmetric key is encoded with multiple public keys, each corresponding with one of multiple users, wherein the encoded symmetric key is decodable by each of the users, such that the encrypted recording of the messaging session is decryptable by each of the users utilizing the symmetric key. In addition, message entries may be encrypted and distributed in real-time with an encoded symmetric key for decryption.

### BACKGROUND OF THE INVENTION

1. Technical Field

The present invention relates in general to electronic communications and, in particular, to recording messaging sessions. Still more particularly, the present invention relates to encrypting a message entries of a messaging session and providing users with a common key for decrypting the messaging entries.

2. Description of the Related Art

As the Internet and telephony expand, the ease of communications between individuals in different locations continues to expand as well. One type of electronic communication is supported by messaging which includes the use of computer systems and data communication equipment to convey messages from one person to another, as by e-mail, voice mail, unified communications, instant messaging, or fax.

While e-mail has already expanded into nearly every facet of the business world, other types of messaging continue to forge into use. For example, instant messaging systems are typically utilized in the context of an Internet-supported application that transfers text between multiple Internet users in real time.

In particular, the Internet Relay Chat (IRC) service is one example of instant messaging that enables an Internet user to participate in an on-line conversation in real time with other users. An IRC channel, maintained by an IRC server, transmits the text typed by each user who has joined the channel to the other users who have joined the channel. An IRC client shows the names of the currently active channels, enables the user to join a channel, and then displays the other channel participant's words on individual lines so that the user can respond.

Similar to IRC, chat rooms are often available through on-line services and provide a data communication channel that links computers and permits users to converse by sending text messages to one another in real-time.

Instant messaging sessions continue to replace and/or supplement telephone conversations in business and personal contexts. For example, while a user is logged onto a web site, the user may converse with technical personnel or personal shoppers via an instant messaging session. In another example, employees may discuss a project utilizing an instant messaging session rather than a telephone conversation.

However, messaging systems, and in particular instant messaging systems, are limited in that confidential communications may be carried on, but no method of encrypting these confidential communications is made available.

In view of the foregoing, it would be advantageous to provide a method, system and program for recording and encrypting messaging sessions such that only users with a decryption key have access to the recorded messaging session.

### SUMMARY OF THE INVENTION

In view of the foregoing, it is therefore an object of the present invention to provide an improved method, system and program for performing electronic communications.

It is another object of the present invention to provide a method, system and program for recording messaging sessions.

It is yet another object of the present invention to provide a method, system and program for encrypting a message entries within a messaging session and providing users with a key for decrypting the message entries.

According to one aspect of the present invention, a recording of a messaging session is encrypted with a symmetric key, wherein the symmetric key is enabled to decrypt the encrypted recording of the messaging session. The symmetric key is encoded with multiple public keys, each corresponding with one of multiple users, wherein the encoded symmetric key is decodable by each of the users, such that the encrypted recording of the messaging session is decryptable by each of the users utilizing the symmetric key.

According to another aspect of the present invention, a message entry is encrypted with a symmetric key at a client messaging system. The encrypted messaging entry is then transmitted for distribution to multiple recipient client messaging systems, such that the message entry is encrypted with the symmetric key enabled to decrypt the message entry prior to transmission across a network.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic messaging typically takes place in accordance with the method, system and program of the present invention;

FIG. 3 depicts a block diagram of one embodiment of a messaging server in accordance with the method, system and program of the present invention;

FIG. 4 illustrates a block diagram of one embodiment of a real-time encryption system in accordance with the method, system, and program of the present invention;

FIG. 5 depicts a graphical representation of a messaging session interface in accordance with the method, system and program of the present invention;

FIG. 6 illustrates a block diagram of an encoded symmetric key in accordance with the method system and program of the present invention;

FIG. 7 depicts a high level logic flowchart of a process and program for controlling encryption and recording of messaging sessions in accordance with the method, system, and program of the present invention; and

FIG. 8 illustrates a high level logic flowchart of a process and program for controlling a client messaging system in accordance with the method, system and program of the present invention.

### DETAILED DESCRIPTION OF THE PREFERRED EMBODIMENT

A method, system and program are provided for generating a symmetric key, encrypting a recorded messaging session with the symmetric key, and distributing the encrypted recorded messaging session.

A “messaging session” preferably includes, but is not limited to, any combination of voice, graphical, video, and/or text messages, instant and/or delayed, transmitted between multiple users via a network. Message entries within a messaging session may further included embedded text, video, still pictures, audio and other communication media. Messaging sessions may include use of on-line meetings, chat rooms, instant messages, e-mail, IRC, conference calling and other network methods of providing a channel for users to communicate within. Further, messaging sessions may include communications such as voice, video, and text transmissions between multiple telephony devices.

A “symmetric key”, or common key, is preferably an autoencryption key that may be generated utilizing multiple encryption methods. In a preferred embodiment, the public keys of users participating in a messaging session are utilized to encode the symmetric key before transmission to the users.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### HARDWARE OVERVIEW

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

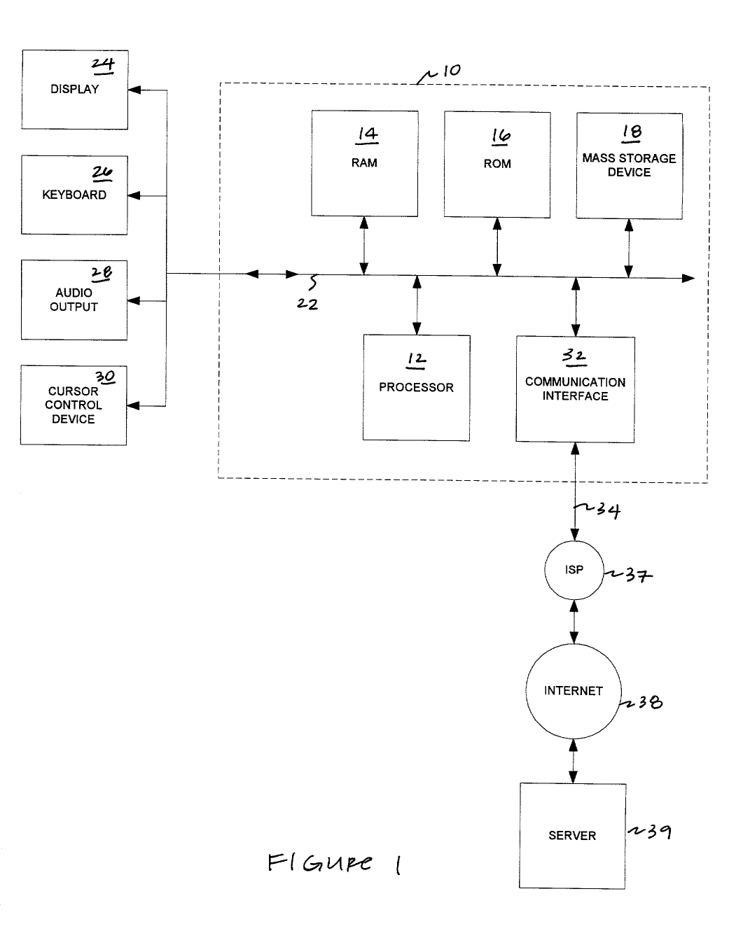

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

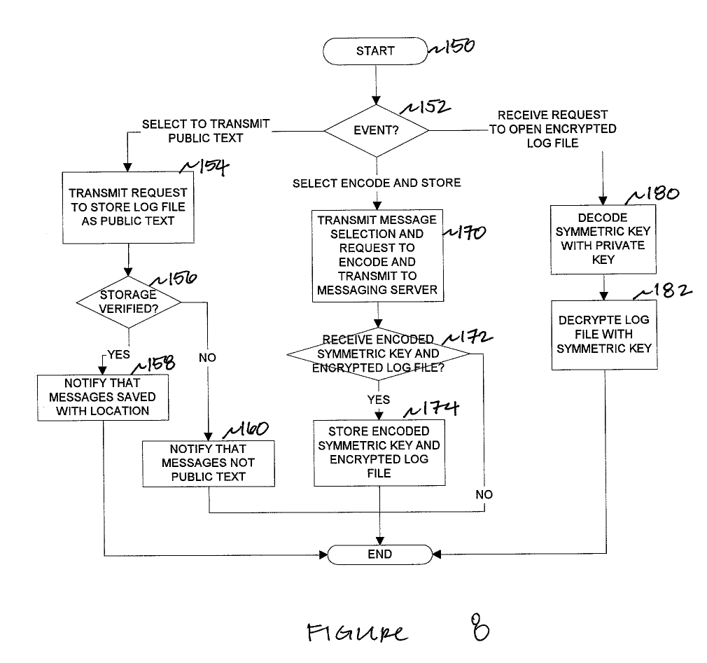

Processor 12 may be a general-purpose processor such as IBM's PowerpC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 7, 8, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### MESSAGING SYSTEMS CONTEXT

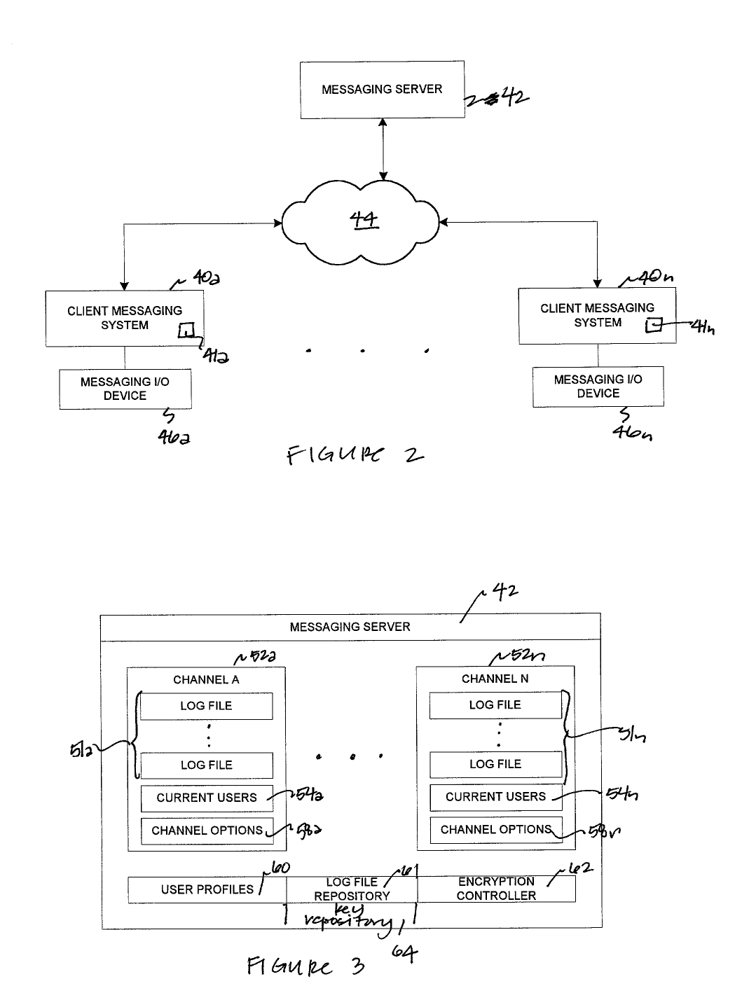

With reference now to FIG. 2, there is depicted a simplified block diagram of a client/server environment in which electronic messaging typically takes place in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Advantageously, in the present invention, a client enters a message via one of messaging input/output (I/O) devices 46a-46n for a messaging session at a client messaging system such as client messaging system 40a. The message entry is transmitted to messaging server 42. Messaging server 42 then distributes the message entry to the user participating in the messaging session via network 44.

In addition, in the present invention, a user at each of client messaging systems 40a-40n may request to record or log a messaging session. Such requests are transmitted to messaging server 42. Messaging server 42 may then record the messaging session until the user at one of client messaging systems 40a-40n requests to stop logging. Then, the user at one of client messaging systems 40a-40n may request that the recording be stored either as public text or as private text, which requires encoding.

If the recording is stored as public text at messaging server 42, client messaging systems 40a-40n, or another data storage system accessible via network 44, then any user may access the recording. Public text, as well as private text, may include alternate security devices and verification devices such as watermarking and digital signatures attached thereto.

However, if the recording is stored as private text, then first a symmetric key is generated by messaging server 42. The symmetric key is utilized by messaging server 42 to encrypt the recording of the messaging session. Then, the symmetric key is encoded with the public keys of each user participating in the messaging session, such that the symmetric key is secure from tampering and can be utilized for easy encryption and decryption. The encrypted messaging session is then stored at messaging server 42, client messaging systems 40a-40n, or other data storage systems accessible via network 44. Advantageously, the symmetric key may be stored at a secure location, such that the symmetric key may be recovered if it is lost.

In particular, a user may be given the option to record text as private text, in which case encryption is automatically performed. Alternatively, a user may be given the option to select to generate the symmetric key, request that the symmetric key be encoded and transmitted to a selection of users and then request that the recorded messaging session be encrypted and transmitted to the selection of users. In addition, a user may select from alternate methods of encryption or alternate levels of encryption.

While in the present embodiment messaging server 42 handles transmission of message entries, recording of messaging sessions and encryption thereof, in alternate embodiments, encrypted messaging sessions and encoded symmetric keys may be accessible to client messaging systems 40a-40n as files in a directory that is accessible to a user. In addition, the encrypted messaging sessions and encoded symmetric keys may be transmitted as e-mail to participants in the messaging session, where the e-mail application functioning on the client messaging system automatically determines that the e-mail contains an encrypted messaging session and decodes the symmetric key and then decrypts the encrypted messaging session with the decoded symmetric key. Moreover, the present invention may utilize a traditional IRC channel for transmitting message entries and a special IRC device channel opened in parallel with the traditional IRC channel for transmitting the encoded symmetric keys and encrypted messaging sessions among users. Furthermore, other types of messaging systems may be utilized to implement the present invention, as will be understood by one skilled in the art.

Advantageously, the steps of requesting to record, requesting to stop recording, and requesting that recordings be stored as public text or private text are performed by an application executing in each of client messaging systems 40a-40n, such as client recording applications 41a-41n. In addition, client recording applications 41a-41n may control transmission of a public key for the user to messaging server 42, and may perform steps of creating a symmetric key and encryption, particularly where client messaging systems 40a-40n are communicating in a peer-to-peer network.

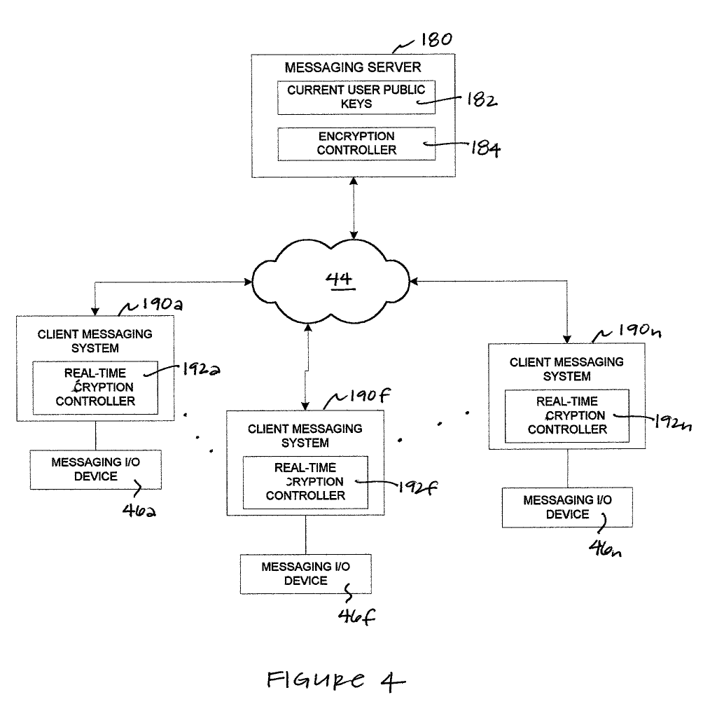

Referring now to FIG. 3, there is illustrated a block diagram of one embodiment of a messaging server in accordance with the method, system and program of the present invention. As depicted messaging server 42 includes an encryption controller 62 that is provided to control the process steps of messaging server 42 as will be further described.

Messaging server 42 also includes multiple channels 52a-52n. Each of channels 52a-52n may represent a separate information path within messaging server 42 in which multiple users may participate in a messaging session. Messaging server 42 may have a defined number of channels 52a-52n or may allow users to create new channels as needed. In particular, channels provide network paths between multiple users for both voice and text communications. Each of channels 52a-52n may further include multiple distinguishable topics.

In addition, each of channels 52a-52n preferably includes a table of current users 54a-54n. As a user selects to participate in channels 52a-52n, the user's identification is attached to the table of current users 54a-54n for that channel.

Preferably, as messaging server 42 receives messages, they may be stored according to the channel, topic and user and then distributed to each of the users participating in that channel. Where both voice and text are being utilized in a single messaging session, messaging server 42 may transmit both voice and text or messaging server 42 may translate all entries into either voice or text before distributing entries to the users participating in the channel.

Messaging entries are preferably stored within each channel in one of log files 51a-51n. Advantageously, multiple users may request to record different selections of the message entries for a messaging session where a new log file is utilized for each request. For example, one user may request to record message entries from a selection of users from among all the users while another user may request to record message entries during a particular time interval of the messaging session.

When a user has finished recording the desired portions of a messaging session, the log file for that user may be stored in a log file repository 61. In particular, in the present invention a user may select to store the log file as public text or private text. When a log file is stored as public text, no encryption is necessary for storing the log file in log file repository 61. However, when a log file is stored as private text, then the log file is encrypted according to the present invention prior to storage in log file repository 61.

Advantageously, log file repository 61 catalogs messaging session recordings such that multiple users may easily access the recordings. While in the present invention log file repository 61 is depicted within messaging server 42, in alternate embodiments log file repository 61 may be included in an alternate server system. Alternatively, log files may be transmitted from messaging server 42 to client messaging systems for storage or may be logged in one of the client messaging systems during the messaging session.

Messaging server 42 includes a user profiles database 60 that includes profile information for each user, including, but not limited to, a user identification, a name, an e-mail address, public key and a user history recorded as the user participates in messaging sessions. The user identification stored in user profiles 60 during registration is utilized across multiple channels for identifying entries provided by that user. The public key may be utilized to encode a symmetric key or other decryption key transmitted to a user. The user may then utilize a private key to decode the symmetric key and then utilize the symmetric key to decode the contents of a recorded messaging session.

Channel options are included with each channel as depicted by channel options 58a-58n. Channel options preferably include encryption levels required to record message entries within a messaging session. Advantageously, channel options may be selected when a user requests a new channel. Alternatively, a user may select a channel based on the encryption levels set in the channel options for that channel. Moreover, a business or other network service provider may automatically set channel options for each of channels 52a-52n.

Encryption controller 62 is advantageously a software application executing within messaging server 42 to control the process of creating a symmetric key, encrypting a recorded messaging session with the symmetric key, encoding the symmetric key with user public keys and transmitting the encrypted messaging session to users.

A key repository 64 advantageously provides a storage device for storing symmetric keys generated to encrypt messaging sessions. In particular, a list of users sent each symmetric key may be stored such that the users included in the list may request the symmetric key when needed. In addition, the symmetric key is stored such that a system administrator, business, or other individual responsible for messaging server 42 is able to decrypt any recording encrypted by messaging server 42.

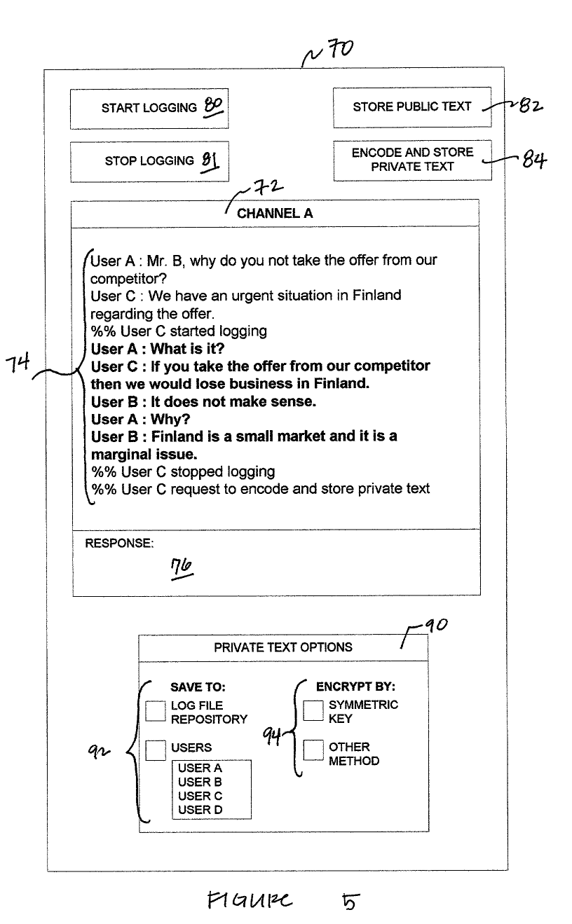

With reference now to FIG. 4, there is depicted a block diagram of one embodiment of a real-time encryption system in accordance with the method, system, and program of the present invention. As illustrated, a messaging server 180 includes a database of current user public keys 182 and an encryption controller 184 in addition to other elements not illustrated. Advantageously, when a user logs onto messaging server 180 from one of client messaging systems 190a-190n, the public key for that user is transmitted to messaging server 180 for storage while the user is logged on. In addition, the public key for the user may be stored at an alternate location and retrieved into the database of current user public keys 182 when the user is detected as having logged on.

According to one aspect of the present invention, encryption controller 184 may generate a symmetric key for encryption of a message entry and encode the symmetric key with the public key of a user logged onto messaging server 180. The encoded symmetric key is then transmitted to a client messaging system, such as client messaging system 190a. A real-time cryption controller 192a decodes the encoded symmetric key and encrypts the message entry with the symmetric key prior to transmittal to messaging server 180.

Messaging server 180 receives the encrypted message entry and encodes the symmetric key with the public keys of the intended recipients of the encrypted message entry. Then, messaging server 180 distributes the encrypted message entry and encoded symmetric keys to multiple recipient client messaging systems, such as client messaging systems 190f and 190n. Real-time cryption controllers 192f and 192n decode the symmetric key utilizing the matching private key and then decrypt the encrypted message entry with the symmetric key.

Alternatively, client messaging system 190a may generate the symmetric key and encode the symmetric key with the public keys of intended recipients. Client messaging system 190a will then distribute the encoded symmetric keys and encrypted message entry to client messaging systems 190f and 190n.

According to one advantage of the present invention, message entries are encrypted in real-time such that security of message entries is added during a messaging session, rather than just after the message entries are recorded. Further, an advantage of the present invention is that message entries are encrypted in real-time with a symmetric key such that multiple client messaging systems may receive and decrypt the encrypted message entry in real-time.

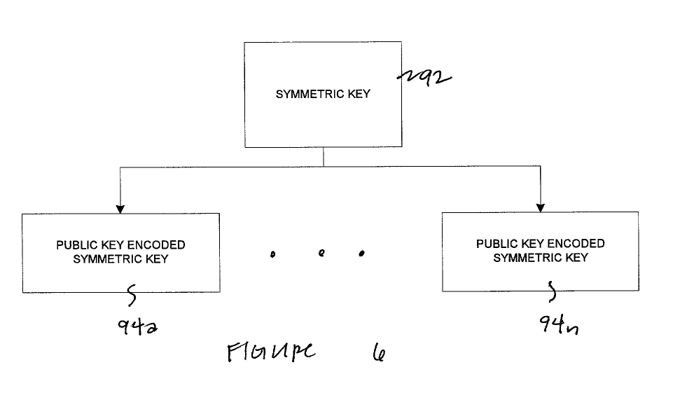

Referring now to FIG. 5, there is depicted a graphical representation of a messaging session interface in accordance with the method, system and program of the present invention. As depicted, a messaging session interface 70 includes a messaging session window 72. For the present example, messaging session interface 70 is accessible to user B, however in alternate embodiments, alternate users may have access to messaging session interface 70.

Messaging session entries 74 are depicted within messaging session window 72. Messaging session entries 74 include message entries by users A, B, and C and textual references to logging activity by user C. As illustrated within messaging session entries 74, after user C requested to start logging, the message entries following are textually distinguishable in bold to indicate that the message entries are being recorded. Moreover, alternative types of indicators that message entries are being recorded may be utilized. For example, a graphical or audible indicator may be provided. In addition, as depicted within messaging session entries 74, when user C requested to stop logging, user C then requested to encode and store the logging as private text.

Advantageously, messaging session window 72 may represent an on-line meeting where it is important to record and encrypt recordings of confidential information shared during the on-line meeting. Although one graphical example of a messaging session is depicted in the present invention, alternate types of graphical, video, audio, and textual messaging sessions may be utilized with the present invention.

A response block 76 is also illustrated within messaging session window 72. Response block 76 is provided to allow a user to enter either a textual, graphical, or audible message to be included in the messaging session.

Messaging session interface 70 also includes multiple selectable buttons 80, 81, 82 and 84. In response to a user selecting selectable button 80, a request to log the conversation is transmitted to the messaging server. In addition, in response to a user selecting selectable button 81, a request to stop logging the conversation is transmitted to the messaging server.

In response to a user selecting selectable button 82, a request is transmitted to the messaging server to store the portions of the messaging session logged by the user as public text. In storing the recorded messaging session as public text, the log file may be stored at client messaging systems, the messaging server or other data storage locations.

In response to a user selecting selectable button 84, a request is transmitted to the messaging server that the portions of the messaging session logged by the user are encoded and stored as private text. Alternatively, where the client messaging systems are engaged in peer-to-peer communication, a user selection of selectable button 84 will cause the client messaging system to encode and store the recording.

In addition, in response to a user selection of selectable button 84 the user may be provided encryption options such as those depicted in graphical window 90. For example, the user may select where to save the encrypted log file, including a log file repository and particular users, as illustrated at indicator 92. In another example, the user may select a type of encryption to utilize, such as symmetric key encryption, as depicted at indicator 94.

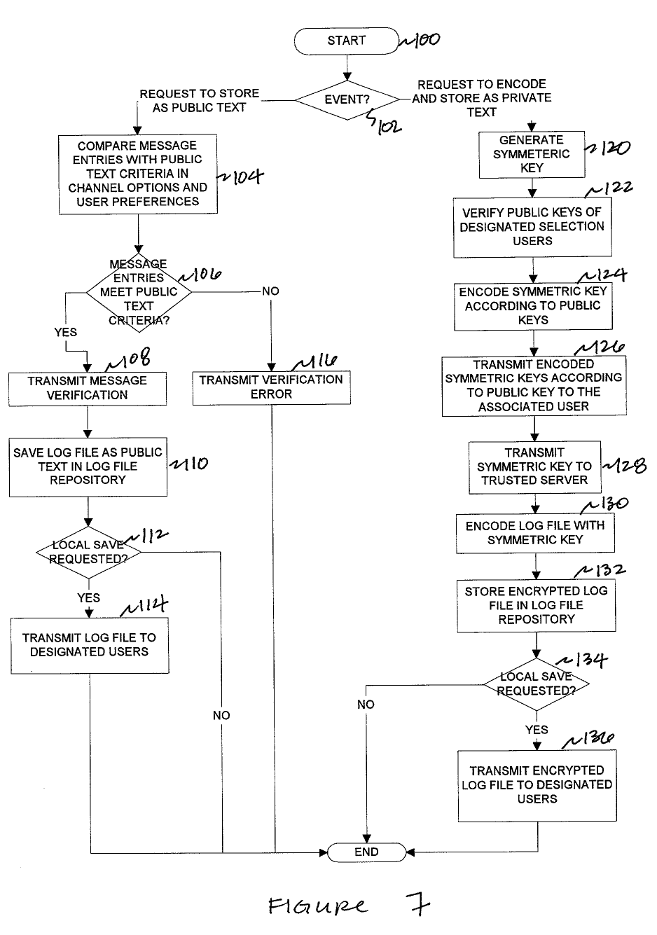

With reference now to FIG. 6, there is a block diagram of an encoded symmetric key in accordance with the method system and program of the present invention. As illustrated, a symmetric key 92 has been generated as an encryption and decryption key for a recorded messaging session. In order to transmit the symmetric key to multiple users such that those users may decrypt the recorded messaging session, the symmetric key is encoded with a public key associated with each user as illustrated by reference numerals 94a-94n. The encoded symmetric keys are then transmitted according to the public key of the associated user.

One advantage of the present invention is that a single symmetric key is utilized for encryption and decryption such that even if user public keys change, the symmetric key may be utilized to decrypt the encrypted messaging session. In addition, the symmetric key can be stored at a secure site such that if a user loses the encoded symmetric key or the user changes public keys, then that user may access the symmetric key from the secure site.

Referring now to FIG. 7, there is illustrated a high level logic flowchart of a process and program for controlling encryption and recording of messaging sessions in accordance with the method, system, and program of the present invention. As depicted, the process starts at block 100 and thereafter proceeds to block 102. Block 102 illustrates a determination as to which event occurred when an event occurs. If a request to store a log file as public text is received, then the process passes to block 104. If a request to encode and store a log file as private text is received, then the process passes to block 120.

Block 104 depicts comparing the recorded message entries with public text criteria in the channel options and user preferences. In particular, channel options may designate particular keywords, topics, types of graphics, and other specified categories of message entries that may not be recorded as public text. In addition, user preferences for users participating in the messaging session may include specifications for categories of message entries that may not be recorded as public text.

Next, block 106 illustrates a determination as to whether or not the message entries meet the public text criteria. If the message entries meet the public text criteria, then the process passes to block 108. If the message entries do not meet the public text criteria, then the process passes to block 116. Block 116 depicts transmitting a verification error indicating that the message entries may not be stored as public text; and the process ends.

Block 108 depicts transmitting a message verification indicating the message entries may be stored as public text. Next, block 110 illustrates saving the log file of recorded messaging entries into a log file repository. Thereafter, block 112 depicts a determination as to whether or not a local save is requested. In particular, a local save includes a request to transmit the log file to the requesting user and to other users participating in the messaging session. If a local save is not requested, then the process ends. If a local save is requested, then the process passes to block 114. Block 114 illustrates transmitting the log file to a designated selection of users and the process ends.

Block 120 illustrates generating a symmetric key. A symmetric key may include a combination of alphanumerics, graphics and audio. Next, block 122 depicts verifying the public keys of a designated selection of the users. Users may provide a public key in association with a user identification. In addition, even where a public key is stored in association with a user identification, users may be requested to verify that the public key is current. Thereafter, block 124 illustrates encoding the symmetric key according to the public keys and the process passes to block 126. In particular, when the symmetric key is encoded with a public key, each user is required to use a private key to decode the symmetric key, thereby protecting the symmetric key from tampering or from use by an unauthorized user.

Block 126 depicts transmitting the encoded symmetric keys according to public key to the associated user. Next, block 128 illustrates transmitting the symmetric key to a trusted server. Thereafter, block 130 depicts encoding the log file with the symmetric key. Further, block 132 illustrates storing the encrypted log file in a log file repository and the process passes to block 134.

Block 134 illustrates a determination as to whether or not a local save is requested. If a local save is not requested, then the process ends. If a local save is requested, then the process passes to block 136. Block 136 depicts transmitting the encrypted log file to a designated selection of users and the process ends.

With reference now to FIG. 8, there is illustrated a high level logic flowchart of a process and program for controlling a client messaging system in accordance with the method, system and program of the present invention. As depicted, the process starts at block 150 and thereafter proceeds to block 152. Block 152 illustrates a determination as to which event occurred when an event occurs. If a selection to store public text is received, then the process passes to block 154. If a selection to encode and store private text is received, then the process passes to block 170. Or, if a request to open an encrypted log file is received, then the process passes to block 180.

Block 154 depicts transmitting a request to store a recorded log file as public text. Next, block 156 illustrates a determination as to whether the storage is verified. If storage is verified, then the process passes to block 158 where a notification is output that the log file is stored as public text; and the process ends. If storage is not verified, then the process passes to block 160 where a notification is output that the log file was not stored as public text; and the process ends.

Block 170 illustrates transmitting a request to encode and store a recorded log file as private text. Next, block 172 depicts a determination as to whether or not an encoded symmetric key and encrypted log file are received. If an encoded symmetric key and encrypted log file are not received, then the process ends. If an encoded symmetric key and encrypted log file are received, then the process passes to block 174. Block 174 illustrates storing the encoded symmetric key and encrypted log file and the process ends.

Block 180 depicts decoding the encoded symmetric key with a private key. Next, block 182 illustrates decrypting the encrypted log file with the symmetric key and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for encrypting a messaging session, said method comprising the steps of:
encrypting a recording of a messaging session with a symmetric key, wherein said symmetric key is enabled to decrypt said encrypted recording of said messaging session; and
encoding said symmetric key with a plurality of public keys each corresponding with one from among a plurality of users, wherein said encoded symmetric key is decodable by each of said plurality of users, such that said encrypted recording of said messaging session is decryptable by each of said plurality of users utilizing said symmetric key.

2. The method for encrypting a messaging session according to claim 1, said method further comprising the step of:
encrypting said recording and encoding said symmetric key at a messaging server system communicatively connected to a network to a plurality of client messaging systems.

3. The method for encrypting a messaging session according to claim 1, said method further comprising the step of:
encrypting said recording and encoding said symmetric key at a particular client messaging system communicatively connected to a network to a plurality of client messaging systems.

4. The method for encrypting a messaging session according to claim 1, said method further comprising the step of:
recording a selection of a plurality of message entries from a messaging session.

5. The method for encrypting a messaging session according to claim 1, said method further comprising the step of:
generating a symmetric key comprising at least one of alphanumeric, graphic, and audio elements.

6. The method for encrypting a messaging session according to claim 1, said method further comprising the step of:
distributing said encoded symmetric key according to said plurality of public keys each corresponding with one from among said plurality of users.

7. The method for encrypting a messaging session according to claim 1, said method further comprising the step of:
distributing said encrypted recording of said messaging session to said plurality of users.

8. The method for encrypting a messaging session according to claim 1, said method further comprising the step of:
storing said symmetric key in a secure file only accessible to a selection of said plurality of users and an administrator for said messaging session.

9. A system for encrypting a messaging session, said system comprising:
a messaging server communicatively connected to a network to a plurality of client messaging systems each associated with one from among a plurality of users;
means for encrypting a recording of a messaging session with a symmetric key, wherein said symmetric key is enabled to decrypt said encrypted recording of said messaging session; and
means for encoding said symmetric key with a plurality of public keys each corresponding with one from among said plurality of users, wherein said encoded symmetric key is decodable by each of said plurality of users, such that said encrypted recording of said messaging session is decryptable by each of said plurality of users utilizing said symmetric key.

10. The system for encrypting a messaging session according to claim 9, said system further comprising:
means for recording a selection of a plurality of message entries from a messaging session.

11. The system for encrypting a messaging session according to claim 9, said system further comprising:
means for generating a symmetric key comprising at least one of alphanumeric, graphic, and audio elements.

12. The system for encrypting a messaging session according to claim 9, said system further comprising:
means for distributing said encoded symmetric key according to said plurality of public keys each corresponding with one from among said plurality of users.

13. The system for encrypting a messaging session according to claim 9, said system further comprising:
means for distributing said encrypted recording of said messaging session to said plurality of users.

14. The system for encrypting a messaging session according to claim 9, said system further comprising:
means for storing said symmetric key in a secure file only accessible to a selection of said plurality of users and an administrator for said messaging session.

15. A program for encrypting a messaging session, residing on a computer usable medium having computer readable program code means, said program comprising:
means for controlling encryption of a recording of a messaging session with a symmetric key, wherein said symmetric key is enabled to decrypt said encrypted recording of said messaging session; and
means for controlling encoding said symmetric key with a plurality of public keys each corresponding with one from among a plurality of users, wherein said encoded symmetric key is decodable by each of said plurality of users, such that said encrypted recording of said messaging session is decryptable by each of said plurality of users utilizing said symmetric key.

16. The program for encrypting a messaging session according to claim 15, said program further comprising:
means for recording a selection of a plurality of message entries from a messaging session.

17. The program for encrypting a messaging session according to claim 15, said program further comprising:
means for generating a symmetric key comprising at least one of alphanumeric, graphic, and audio elements.

18. The program for encrypting a messaging session according to claim 15, said program further comprising:
means for enabling distribution of said encoded symmetric key according to said plurality of public keys each corresponding with one from among said plurality of users.

19. The program for encrypting a messaging session according to claim 15, said program further comprising:
means for enabling distribution of said encrypted recording of said messaging session to said plurality of users.

20. The program for encrypting a messaging session according to claim 15, said program further comprising:
means for directing storage of said symmetric key in a secure file only accessible to a selection of said plurality of users and an administrator for said messaging session.

21. A method for secure messaging session transmission, said method comprising the steps of:
receiving a key encoded specifically for a particular user and an encrypted messaging session;
decoding said key with a private key for said particular user; and
decrypting said encrypted messaging session with said decoded key, such that said particular user is enabled to receive and securely decrypt said encrypted messaging session.

22. The method for secure messaging session transmission according to claim 21, said method further comprising the step of:
requesting to record a messaging session; and
in response to requesting to record said messaging session, receiving said encrypted messaging session and said key.

23. A system for secure messaging session transmission, said method comprising:
a client messaging system communicatively connected to a network;
means for receiving a key encoded specifically for a particular user and an encrypted messaging session;
means for decoding said key with a private key for said particular user; and
means for decrypting said encrypted messaging session with said decoded key, such that said particular user is enabled to receive and securely decrypt said encrypted messaging session.

24. The system for secure messaging session transmission according to claim 23, said system further comprising:
means for requesting to record a messaging session; and
means for receiving said encrypted messaging session and said key, in response to requesting to record said messaging session.

25. A program for secure messaging session transmission, residing on a computer usable medium having computer readable program code means, said program comprising:
means for enabling receipt of a key encoded specifically for a particular user and an encrypted messaging session;
means for decoding said key with a private key for said particular user; and
means for decrypting said encrypted messaging session with said decoded key, such that said particular user is enabled to receive and securely decrypt said encrypted messaging session.

26. The program for secure messaging session transmission according to claim 25, said program further comprising:
means for controlling transmission of a request to record a messaging session; and
means for enabling receipt of said encrypted messaging session and said key, in response to requesting to record said messaging session.

27. A method for real-time encryption of a message entry transmitted to a plurality of client messaging systems, said method comprising the steps of:
encrypting a message entry with a symmetric key at a client messaging system; and
transmitting said encrypted messaging entry for distribution to a plurality of recipient client messaging systems, such that said message entry is encrypted with said symmetric key enabled to decrypt said message entry prior to transmission across a network.

28. The method for real-time encryption of a message entry transmitted to a plurality of client messaging systems according to claim 27, said method further comprising the steps of:
receiving an encoded symmetric key at a client messaging system; and
decoding said encoded symmetric key with a private key matching a public key utilized to encode said symmetric key.

29. The method for real-time encryption of a message entry transmitted to a plurality of client messaging systems according to claim 27, said method further comprising the step of:
generating said symmetric key at said client messaging system.

30. The method for real-time encryption of a message entry transmitted to a plurality of client messaging systems according to claim 27, said method further comprising the step of:
encoding said symmetric key with a plurality of public keys associated with a plurality of users intended to receive said message entry; and
transmitting said encrypted message entry and said encoded symmetric keys to said plurality of recipient client messaging systems.

31. A system for real-time encryption of a message entry transmitted to a plurality of client messaging systems, said system comprising:
a client messaging system communicatively connected to a network;
means for encrypting a message entry with a symmetric key at a client messaging system; and
means for transmitting said encrypted messaging entry for distribution to a plurality of recipient client messaging systems via said network, such that said message entry is encrypted with said symmetric key enabled to decrypt said message entry prior to transmission across a network.

32. The system for real-time encryption of a message entry transmitted to a plurality of client messaging systems according to claim 31, said system further comprising:
means for receiving an encoded symmetric key at a client messaging system; and
means for decoding said encoded symmetric key with a private key matching a public key utilized to encode said symmetric key.

33. The system for real-time encryption of a message entry transmitted to a plurality of client messaging systems according to claim 31, said system further comprising:
means for generating said symmetric key at said client messaging system.

34. The system for real-time encryption of a message entry transmitted to a plurality of client messaging systems according to claim 31, said system further comprising:
means for encoding said symmetric key with a plurality of public keys associated with a plurality of users intended to receive said message entry; and
means for transmitting said encrypted message entry and said encoded symmetric keys to said plurality of recipient client messaging systems.

35. A program for real-time encryption of a message entry transmitted to a plurality of client messaging systems, residing on a computer usable medium having computer readable program code means, said program comprising:
means for encrypting a message entry with a symmetric key at a client messaging system; and
means for enabling transmission of said encrypted messaging entry for distribution to a plurality of recipient client messaging systems, such that said message entry is encrypted with said symmetric key enabled to decrypt said message entry prior to transmission across a network.

36. The program for real-time encryption of a message entry transmitted to a plurality of client messaging systems according to claim 35, said program further comprising:
means for enabling receipt of an encoded symmetric key at a client messaging system; and
means for decoding said encoded symmetric key with a private key matching a public key utilized to encode said symmetric key.

37. The program for real-time encryption of a message entry transmitted to a plurality of client messaging systems according to claim 35, said program further comprising:
means for generating said symmetric key at said client messaging system.

38. The program for real-time encryption of a message entry transmitted to a plurality of client messaging systems according to claim 35, said program further comprising:
means for encoding said symmetric key with a plurality of public keys associated with a plurality of users intended to receive said message entry; and
means for enabling transmission of said encrypted message entry and said encoded symmetric keys to said plurality of recipient client messaging systems.

39. A method for controlling real-time distribution of encrypted messages, said method comprising the steps of:
transmitting a symmetric key encoded for a particular user to a client messaging system;
receiving a message entry from said client messaging system, wherein said message entry is encrypted with said symmetric key;
encoding said symmetric key for a plurality of intended recipients; and
transmitting said message entry and said encoded symmetric key to said plurality of intended recipients, such that said encrypted message entry is distributed in real-time to said plurality of intended recipients.

40. A system for controlling real-time distribution of encrypted messages, said system comprising:
a messaging server communicatively connected to a network;
means for transmitting a symmetric key encoded for a particular user to a client messaging system;
means for receiving a message entry from said client messaging system, wherein said message entry is encrypted with said symmetric key;
means for encoding said symmetric key for a plurality of intended recipients; and
means for transmitting said message entry and said encoded symmetric key to said plurality of intended recipients, such that said encrypted message entry is distributed in real-time to said plurality of intended recipients.

41. A program for controlling real-time distribution of encrypted messages, residing on a computer usable medium having computer readable program code means, said program comprising:
means for enabling transmission of a symmetric key encoded for a particular user to a client messaging system;
means for enabling receipt of a message entry from said client messaging system, wherein said message entry is encrypted with said symmetric key;
means for encoding said symmetric key for a plurality of intended recipients; and
means for enabling transmission of said message entry and said encoded symmetric key to said plurality of intended recipients, such that said encrypted message entry is distributed in real-time to said plurality of intended recipients.
